(19) United States
(12) Patent Application Publication
(10) Pub. No.: US 2013/0229407 A1
(43) Pub. Date: Sep. 5, 2013

(54) STEREO DISPLAY APPARATUS

(71) Applicants: Kun-Chi Chiu, Miaoli County (TW); Yun-Chih Chen, Taoyuan County (TW); Hung-Hsiang Chen, Taoyuan County (TW); Jiun-Ty Huang, Yilan County (TW)

(72) Inventors: Kun-Chi Chiu, Miaoli County (TW); Yun-Chih Chen, Taoyuan County (TW); Hung-Hsiang Chen, Taoyuan County (TW); Jiun-Ty Huang, Yilan County (TW)

(73) Assignee: CHUNGHWA PICTURE TUBES, LTD., Taoyuan (TW)

(21) Appl. No.: 13/569,180

(22) Filed: Aug. 8, 2012

(30) Foreign Application Priority Data
Mar. 1, 2012 (TW) 101106754

(51) Int. Cl. G06T 15/00

(52) U.S. Cl. 345/419

(57) ABSTRACT

A stereo display apparatus includes a display panel and an adjustable barrier. The display panel is capable of providing an image. The adjustable barrier is located on a transmission path of the image. The adjustable barrier includes a first substrate, a second substrate disposed opposite to the first substrate, and a display medium located between the first substrate and the second substrate. The second substrate includes a second plate, a plurality of first electrodes, and a plurality of second electrodes. The first and second electrodes are located on the second plate. The first electrodes are arranged in a same space. The second electrodes and the first electrodes are alternately arranged. The second electrodes are arranged in a same space. A first space is between any two adjacent first electrodes. A second space is between any two adjacent second electrodes. The first space is greater than the second space.

### CROSS-REFERENCE TO RELATED APPLICATION

This application claims the priority benefit of Taiwan application serial no. 101106754, filed on Mar. 1, 2012. The entirety of the above-mentioned patent application is hereby incorporated by reference herein and made a part of this specification.

### BACKGROUND OF THE INVENTION

1. Field of the Invention

The invention relates to a stereo display apparatus. More particularly, the invention relates to a stereo display apparatus capable of adjusting the optimum viewing distance.

2. Description of Related Art

At present, stereo display techniques can be roughly divided into stereoscopic techniques which require a user to wear a specially designed pair of glasses, and auto-stereoscopic techniques which allow a user to directly watch an image with a naked eye. The mature development of the stereoscopic techniques is evident, and such techniques have been extensively applied in military simulations or large entertainment venues. Nonetheless, because of inconvenience and discomfort of wearing glasses, the stereoscopic techniques are less applicable. As a result, the auto-stereoscopic techniques have been gradually developed and have become the leading technology.

A conventional auto-stereoscopic display includes a display panel for providing an image and a parallax barrier configured on a transmission path of the image. The space among the light shielding regions of the parallax barrier needs to be accurately aligned to pixels in the display panel, such that the auto-stereoscopic display is capable of accomplishing favorable stereo display effects. Normally, since the space among the light shielding regions of the parallax barrier has a fixed value, the optimum viewing distance to the auto-stereoscopic display remains constant. Thereby, if a user intends to change the viewing distance, the positions of both eyes of the user deviate from the optimum viewing region. As a result, the user is unable to observe the stereo image with satisfactory display quality.

### SUMMARY OF THE INVENTION

The invention is directed to a stereo display apparatus capable of adjusting the viewing distance.

In the invention, a stereo display apparatus that includes a display panel and an adjustable barrier is provided. The display panel is capable of providing an image. The adjustable barrier is located on a transmission path of the image. The adjustable barrier includes a first substrate, a second substrate disposed opposite to the first substrate, and a display medium located between the first substrate and the second substrate. The second substrate includes a second plate, a plurality of first electrodes, and a plurality of second electrodes. The first and second electrodes are located on the second plate. The first electrodes are arranged in a same space. The second electrodes and the first electrodes are alternately arranged. The second electrodes are arranged in a same space. A first space is between any two adjacent first electrodes of the first electrodes. A second space is between any two adjacent second electrodes of the second electrodes. The first space is greater than the second space.

According to an embodiment of the invention, the first electrodes and the second electrodes are alternately arranged along a first direction, and a width of each of the first electrodes along the first direction is less than a width of each of the second electrodes along the first direction.

According to an embodiment of the invention, a first pitch is between any two adjacent first electrodes of the first electrodes, a second pitch is between any two adjacent second electrodes of the second electrodes, and the first pitch is substantially equal to the second pitch.

According to an embodiment of the invention, the first electrodes and the second electrodes are alternately arranged along a first direction, each of the first electrodes and each of the second electrodes are bar-shaped electrodes extending along a second direction, and the second direction and the first direction are staggered.

According to an embodiment of the invention, the first electrodes and the second electrodes are coplanar.

According to an embodiment of the invention, the first substrate includes a first plate and a third electrode. The third electrode is located on the first plate and between the first plate and the second plate. Here, the third electrode is a complete conductive pattern and entirely covers the first electrodes and the second electrodes.

According to an embodiment of the invention, the first substrate includes a first plate and a plurality of fourth electrodes. The fourth electrodes are located on the first plate and between the first plate and the second plate. Besides, the fourth electrodes are arranged in a same space. A fourth space is between any two adjacent fourth electrodes. The first electrodes and the second electrodes are alternately arranged along a first direction. Besides, the fourth electrodes are arranged along a second direction. The first direction and the second direction are staggered.

According to an embodiment of the invention, the first substrate may further include a plurality of fifth electrodes. The fifth electrodes are located on the first plate and between the first plate and the second plate. The fourth electrodes and the fifth electrodes are alternately arranged along the second direction. The fifth electrodes are arranged in a same space. A fifth space is between any two adjacent fifth electrodes. The fourth space is greater than the fifth space.

According to an embodiment of the invention, a width of each of the fourth electrodes along the second direction is less than a width of each of the fifth electrodes along the second direction.

According to an embodiment of the invention, a fourth pitch is between any two adjacent fourth electrodes of the fourth electrodes, a fifth pitch is between any two adjacent fifth electrodes of the fifth electrodes, and the fourth pitch is substantially equal to the fifth pitch.

According to an embodiment of the invention, each of the fourth electrodes and each of the fifth electrodes are bar-shaped electrodes extending along a third direction, and the second direction and the third direction are staggered.

According to an embodiment of the invention, the fourth electrodes and the fifth electrodes are coplanar.

According to an embodiment of the invention, the first substrate includes a first plate and a plurality of fourth electrodes. The fourth electrodes are located on the first plate and between the first plate and the second plate. Besides, the fourth electrodes are arranged in a same space. A fourth space is between any two adjacent fourth electrodes. The first electrodes and the second electrodes are alternately arranged along a first direction. The fourth electrodes are arranged along a second direction, and the second direction is substantially parallel to the first direction.

According to an embodiment of the invention, the first substrate further includes a plurality of fifth electrodes. The fifth electrodes are located on the first plate and between the second plate and the first plate. The fourth electrodes and the fifth electrodes are alternately arranged along the second direction. The fifth electrodes are arranged in a same space. A fifth space is between any two adjacent fifth electrodes. The fourth space is greater than the fifth space.

According to an embodiment of the invention, the first electrodes are substantially aligned to the fourth electrodes, and the second electrodes are substantially aligned to the fifth electrodes.

According to an embodiment of the invention, the first space, the second space, the fourth space, and the fifth space are different from one another.

According to an embodiment of the invention, each of the fourth electrodes and each of the fifth electrodes are bar-shaped electrodes extending along a third direction. The second direction and the third direction are staggered.

According to an embodiment of the invention, the fourth electrodes and the fifth electrodes are coplanar.

According to an embodiment of the invention, the adjustable barrier further includes a polarizer that is connected to the first substrate.

According to an embodiment of the invention, the stereo display apparatus further includes a control unit. The control unit is suitable for adjusting brightness of the image according to transmittance of the adjustable barrier.

Based on the above, in the stereo display apparatus of the invention, electrodes that are not arranged equidistantly are configured on the adjustable barrier, such that the stereo display apparatus of the invention can have the adjustable optimum viewing distance thereto.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A and FIG. 1B are schematic views illustrating a stereo display apparatus according to a first embodiment of the invention.

FIG. 2A shows an adjustable barrier by which the stereo display apparatus depicted in FIG. 1A is in a mode of three-dimensional (3D) long viewing distance.

FIG. 2B shows an adjustable barrier by which the stereo display apparatus depicted in FIG. 1B is in a mode of 3D short viewing distance.

FIG. 3 is a schematic three-dimensional view illustrating an adjustable barrier according to a second embodiment of the invention.

FIG. 4 is a schematic cross-sectional view illustrating the adjustable barrier taken along a line segment AA′ depicted in FIG. 3.

FIG. 5 is a schematic cross-sectional view illustrating the adjustable barrier taken along a line segment BB′ depicted in FIG. 3.

FIG. 6 is a schematic three-dimensional view illustrating an adjustable barrier according to a third embodiment of the invention.

FIG. 7 is a schematic cross-sectional view illustrating the adjustable barrier taken along a line segment CC′ depicted in FIG. 6.

### DETAILED DESCRIPTION OF EMBODIMENTS

### First Embodiment

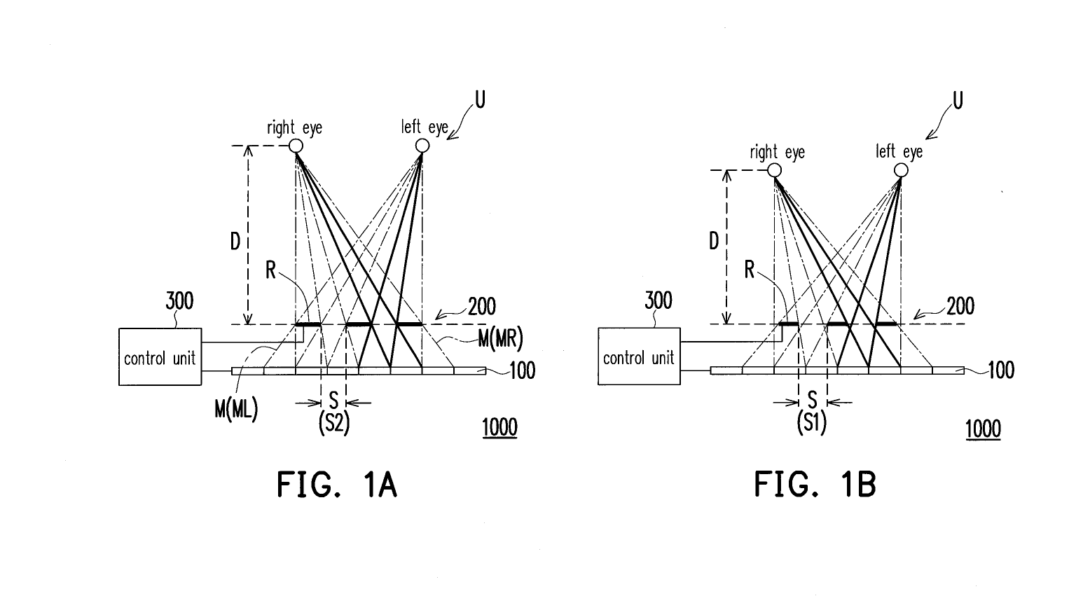

FIG. 1A and FIG. 1B are schematic views illustrating a stereo display apparatus according to a first embodiment of the invention. Specifically, the stereo display apparatus depicted in FIG. 1A is in a 3D-long-viewing-distance mode, while the stereo display apparatus depicted in FIG. 1B is in a 3D-short-viewing-distance mode. With reference to FIG. 1A and FIG. 1B, the stereo display apparatus 1000 described in the present embodiment includes a display panel 100 and an adjustable barrier 200. The display panel 100 is capable of providing an image M. The image M includes a left-eye image ML and a right-eye image MR. The adjustable barrier 200 is located on a transmission path of the image M. In the present embodiment, the display panel 100 may be a non-self-illuminating display, such as a liquid crystal display (LCD) panel. However, the invention is not limited thereto, and the display panel 100 in other embodiments may be a self-illuminating display, such as an organic light-emitting display panel.

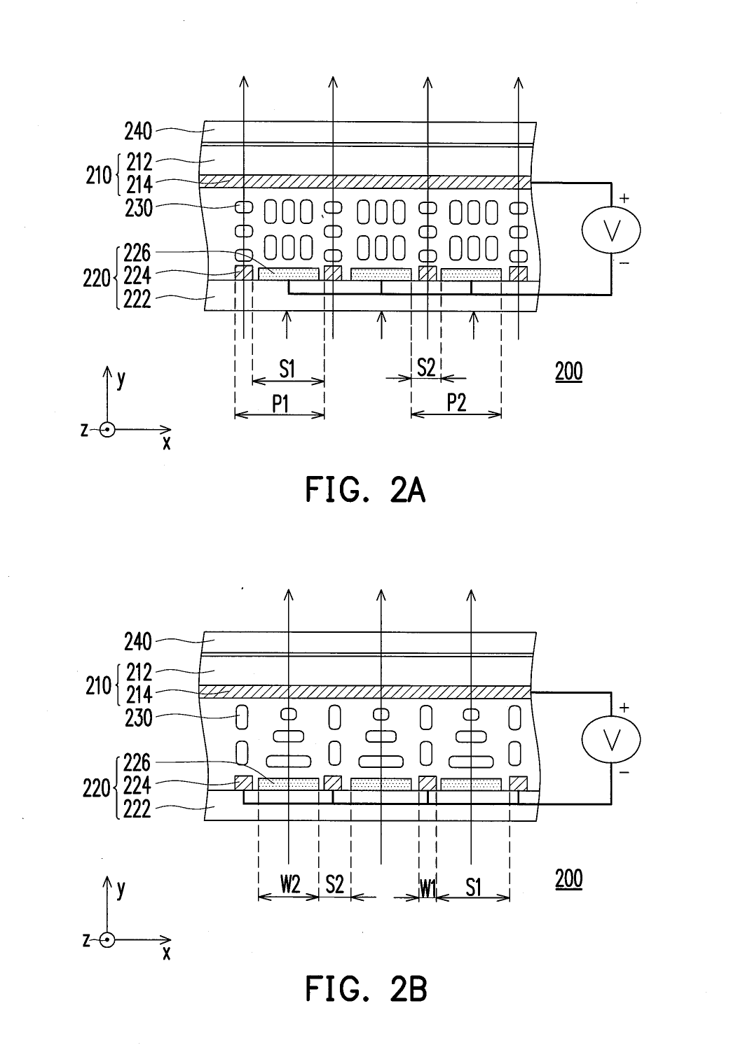

In the present embodiment, the user U, through the adjustable barrier 200, is capable of adjusting the optimum viewing distance D to the stereo display apparatus 1000, and thereby the user in any case is allowed to watch the stereo image with favorable quality. The working principle of adjusting the optimum viewing distance D to the stereo display apparatus 1000 of the present embodiment with use of the adjustable barrier 200 is elaborated hereinafter with reference to FIG. 1A, FIG. 1B, FIG. 2A, and FIG. 2B.

FIG. 2A shows an adjustable barrier by which the stereo display apparatus depicted in FIG. 1A is in a 3D-long-viewing-distance mode. FIG. 2B shows an adjustable barrier by which the stereo display apparatus depicted in FIG. 1B is in a 3D-short-viewing-distance mode. With reference to FIG. 2A and FIG. 2B, the adjustable barrier 200 described in the present embodiment includes a first substrate 210, a second substrate 220 disposed opposite to the first substrate 210, and a display medium 230 located between the first substrate 210 and the second substrate 220. In the present embodiment, the display medium 230 is liquid crystal, for instance. Besides, the adjustable barrier 200 of the present embodiment may further include a polarizer 240 connected to the first substrate 210.

The second substrate 220 of the present embodiment includes a second plate 222, a plurality of first electrodes 224 located on the second plate 222 and between the second plate 222 and the first substrate 210, and a plurality of second electrodes 226 located on the second plate 222 and between the second plate 222 and the first substrate 210. The second electrodes 226 and the first electrodes 224 are alternately arranged. The first electrodes 224 may be equidistantly arranged. The second electrodes 226 may be equidistantly arranged as well. According to the present embodiment, a first pitch P1 is between any two of the first electrodes 224, a second pitch P2 is between any two the second electrodes 226, and the first pitch P1 may be substantially equal to the second pitch P2. The second electrodes 226 and the first electrodes 224 may be coplanar. Nevertheless, the invention should not be construed as limited to the embodiments set forth above.

To be more specific, the first electrodes 224 and the second electrodes 226 may be alternately arranged along a first direction x, each of the first electrodes 224 and each of the second electrodes 226 may be bar-shaped electrodes extending along a second direction z, and the second direction z and the first direction x are staggered. However, the invention is not limited to the above descriptions, and the shapes of the first and second electrodes 224 and 226 may be properly modified based on actual requirements.

The first substrate 210 of the present embodiment includes a first plate 212 and a third electrode 214 that is located on the first plate 212 and between the first plate 212 and the second plate 222. In the present embodiment, the third electrode 214 may be a complete conductive pattern and entirely covers the first electrodes 224 and the second electrodes 226. However, the invention is not limited to the above descriptions. In another embodiment of the invention, the third electrode 214 may be properly shaped in a different manner.

It should be mentioned that a first space S1 is between any two adjacent first electrodes 224 according to the present embodiment. A second space S2 is between any two adjacent second electrodes 226. Here, the first space S1 is greater than the second space S2. That is to say, the first electrodes 224 and the second electrodes 226 may be alternately arranged along the first direction x. Given that the first electrodes 224 and the second electrodes 226 are equidistantly arranged, a width W1 of each of the first electrodes 224 along the first direction x may be less than a width W2 of each of the second electrodes 226 along the first direction x, as shown in FIG. 2B.

Through respectively controlling the first electrodes 224 and the second electrodes 226 with different spaces in between, the adjustable barrier 200 described in the present embodiment is able to adjust the optimum viewing distance D to the stereo display apparatus 1000. With reference to FIG. 1A and FIG. 2A, in particular, if the optimum viewing distance D to the stereo display apparatus 1000 is required to be long, the first electrodes 224 with the large space S1 in between and the third electrode 214 may not have potential difference, such that light is allowed to pass through regions of the adjustable barrier 200 corresponding to the first electrodes 224. The second electrodes 226 with the small space S2 in between and the third electrode 214 may have potential difference V, such that light is not allowed to pass through the regions of the adjustable barrier 200 corresponding to the second electrodes 226. At this time, as shown in FIG. 1A, the space S between every two of the light shielding regions R (i.e., the space S2 between every two of the second electrodes 226) in the adjustable barrier 200 is relatively small, such that the optimum viewing distance D to the stereo display apparatus 1000 is relatively long. Here, said light shielding regions R refer to the regions corresponding to the second electrodes 226.

With reference to FIG. 1B and FIG. 2B, in particular, if the optimum viewing distance D to the stereo display apparatus 1000 is required to be short, the first electrodes 224 with the large space S1 in between and the third electrode 214 may have the potential difference, such that light is not allowed to pass through regions of the adjustable barrier 200 corresponding to the first electrodes 224. The second electrodes 226 with the small space S2 in between and the third electrode 214 may not have the potential difference, such that light is allowed to pass through the regions of the adjustable barrier 200 corresponding to the second electrodes 226. At this time, as shown in FIG. 1B, the space S between every two of the light shielding regions R (i.e., the space S1 between every two of the first electrodes 224) in the adjustable barrier 200 is relatively large, such that the optimum viewing distance D to the stereo display apparatus 1000 is relatively short. Here, said light shielding regions R refer to the regions corresponding to the first electrodes 224.

Note that the way to operate the adjustable barrier 200 is exemplary. The different types of the display medium 230 or the different configuration of the absorption axis of the polarizer 240 may result in different ways to operate the adjustable barrier 200. Note that the way to operate the adjustable barrier 200 serves to exemplarily describe the invention instead of limiting the scope of the invention.

With reference to FIG. 1A and FIG. 1B, the stereo display apparatus 1000 described in the present embodiment may further include a control unit 300. The control unit 300 is suitable for adjusting brightness of the image M according to transmittance of the adjustable barrier 200. Namely, the control unit 300 keeps the brightness of the stereo display apparatus 1000 consistent even though the stereo display apparatus 1000 is in different modes. For instance, if the stereo display apparatus 1000 described in the present embodiment is in a two-dimensional (2D) display mode, the transmittance of the adjustable barrier 200 is 100%, and the brightness of the image M is N. As indicated in FIG. 1A, if the stereo display apparatus 1000 described in the present embodiment is in a 3D display mode, the transmittance of the adjustable barrier 200 is reduced to 50%. At this time, the control unit 300 is capable of adjusting the backlight source of the display panel 100, so as to increase the brightness of the image M to 2N. Thereby, when the stereo display apparatus 1000 switches from the 2D display mode to the 3D long-viewing-distance mode, the image brightness of the stereo display apparatus 1000 stays unchanged, such that the stereo display apparatus 1000 does not have different image brightness during the mode-switching operation.

Similarly, as indicated in FIG. 1B, if the stereo display apparatus 1000 described in the present embodiment is in a 3D short-viewing-distance mode, the transmittance of the adjustable barrier 200 may be 80%. At this time, the control unit 300 is capable of adjusting the backlight source of the display panel 100, so as to increase the brightness of the image M to 1.25N. Thereby, when the stereo display apparatus 1000 switches from the any other mode to the 3D short-viewing-distance mode, the image brightness of the stereo display apparatus 1000 stays unchanged, such that the stereo display apparatus 1000 does not have different image brightness during the mode-switching operation.

### Second Embodiment

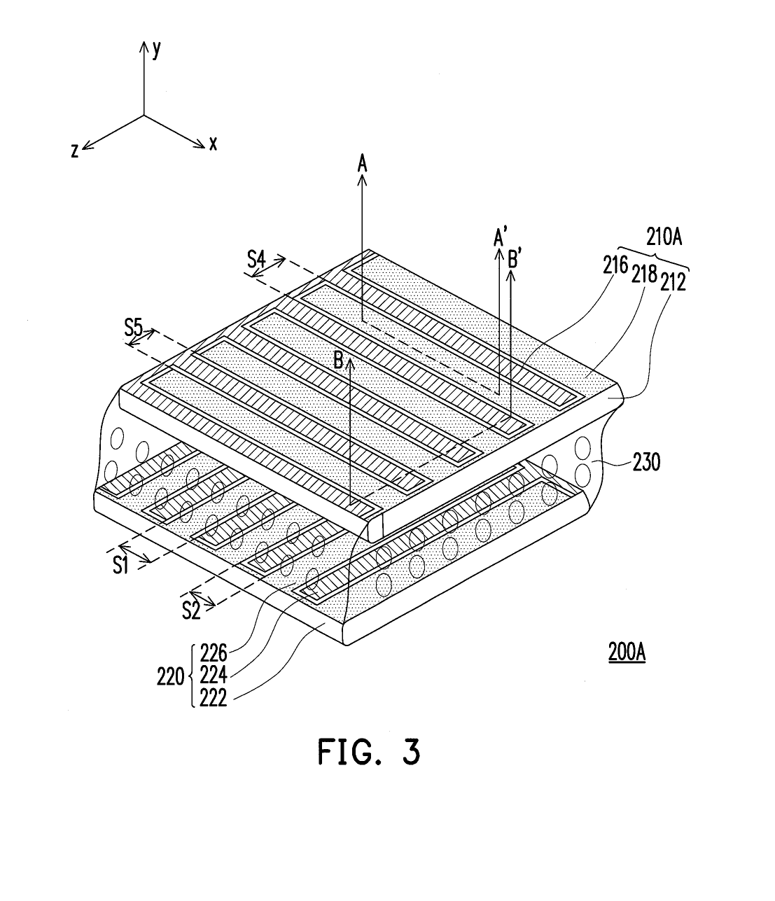

The stereo display apparatus described in the present embodiment is similar to the stereo display apparatus described in the first embodiment, and thus the same or similar reference numerals used in the present embodiment and in the first embodiment represent the same or similar elements. The main difference therebetween lies in the structure of the adjustable barrier. FIG. 3 is a schematic three-dimensional view illustrating an adjustable barrier according to a second embodiment of the invention. The adjustable barrier 200A of the present embodiment is similar to the adjustable barrier 200 of the first embodiment. The difference therebetween lies in that the structure of the first substrate 210A described in the present embodiment is distinct from the structure of the first substrate 210 described in the first embodiment. Said difference will be demonstrated below, while the similarity will not be further described.

With reference to FIG. 3, the adjustable barrier 200A described in the present embodiment includes a first substrate 210A, a second substrate 220 disposed opposite to the first substrate 210A, and a display medium 230 located between the first substrate 210A and the second substrate 220.

The second substrate 220 of the present embodiment includes a second plate 222, a plurality of first electrodes 224 located on the second plate 222, and a plurality of second electrodes 226 located on the second plate 222. The second electrodes 226 and the first electrodes 224 are alternately arranged. The first electrodes 224 may be equidistantly arranged. The second electrodes 226 may be equidistantly arranged as well. A first space S1 is between any two adjacent first electrodes 224. A second space S2 is between any two adjacent second electrodes 226. The first space S1 is greater than the second space S2.

According to the present embodiment, the first substrate 210A includes a first plate 212 and a plurality of fourth electrodes 216. The fourth electrodes 216 are located on the first plate 212 and between the second plate 222 and the first plate 212. Besides, the fourth electrodes 216 are equidistantly arranged. A fourth space S4 is between any two adjacent fourth electrodes 216. In the present embodiment, the fourth space S4 may be the same as the first space S1. However, the invention is not limited thereto, and the fourth space S4 may be different from the first space S1. Note that the first electrodes 222 and the second electrodes 224 are alternately arranged along the first direction x. The fourth electrodes 216 are arranged along the second direction z. The first direction x and the second direction z are staggered. According to the present embodiment, the first direction x may be perpendicular to the second direction z. However, the invention is not limited thereto, and there may be an angle between the first direction x and the second direction z. The angle is not equal to 0 degree, 90 degrees, or 180 degrees.

According to the present embodiment, the first substrate 210A may further include a plurality of fifth electrodes 218. The fifth electrodes 218 are located on the first plate 212 and between the second plate 222 and the first plate 212. The fourth electrodes 216 and the fifth electrodes 218 are alternately arranged along the second direction z. The fifth electrodes 218 are equidistantly arranged. A fifth space S5 is between any two adjacent fifth electrodes 218. The fourth space S4 is greater than the fifth space S5. In the present embodiment, the fifth space S5 may be the same as the second space S2. However, the invention is not limited thereto, and the fifth space S5 may be different from the second space S2.

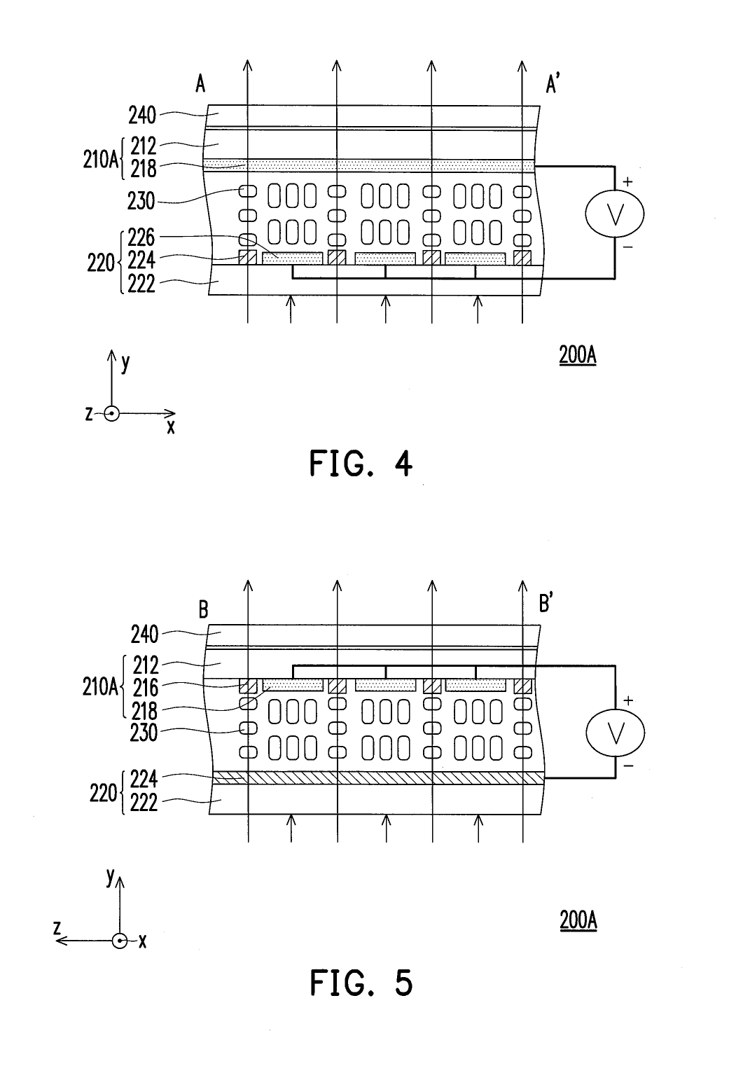

In the present embodiment, an extension direction of the fourth electrodes 216 (or the fifth electrodes 218) is different from an extension direction of the first electrodes 222 and an extension direction of the second electrodes 224. To be more specific, the extension direction of the fourth electrodes 216 (or the fifth electrodes 218) may be parallel to the first direction x. The extension direction of the first electrodes 222 and the extension direction of the second electrodes 224 may be parallel to the second direction z. Due to the extension directions of the fourth electrodes 216 (or the fifth electrodes 218) different from the extension directions of the first and second electrodes 222 and 224, the adjustable barrier 200A described in the present embodiment is not only able to adjust the optimum viewing distance D to the stereo display apparatus but also capable of changing the direction of the displayed stereo image. This will be further exemplified below with reference to FIG. 4 and FIG. 5.

FIG. 4 is a schematic cross-sectional view illustrating the adjustable barrier taken along a line segment AA′ depicted in FIG. 3. FIG. 5 is a schematic cross-sectional view illustrating the adjustable barrier taken along a line segment BB′ depicted in FIG. 3. With reference to FIG. 3 and FIG. 4, when both eyes of a user are located along the direction x, the fourth electrodes 216 and the fifth electrodes 218 of the first substrate 210A have the same potential. A potential difference V may exist between one of the first and second electrodes 224 and 226 of the second substrate 220 and one of the fourth and fifth electrodes 216 and 218, and no potential difference exists between the other one of the first and second electrodes 224 and 226 and the other one of the fourth and fifth electrodes 216 and 218. Thereby, the user whose eyes are positioned along the direction x is able to perceive the stereo image. In addition, the user may change the optimum viewing distance to the stereo display apparatus by adjusting the potential difference between the first electrodes 224 (or the second electrodes 226) and the fourth electrodes 216.

With reference to FIG. 3 and FIG. 5, when both eyes of a user are located along the direction z, the first electrodes 224 and the second electrodes 226 of the second substrate 220 have the same potential. A potential difference V may exist between one of the fourth and fifth electrodes 216 and 218 of the first substrate 210A and one of the first and second electrodes 224 and 226, and no potential difference exists between the other one of the fourth and fifth electrodes 216 and 218 and the other one of the first and second electrodes 224 and 226. Thereby, the user whose eyes are positioned along the direction z is able to perceive the stereo image. In addition, the user may change the optimum viewing distance to the stereo display apparatus by adjusting the potential difference between the fourth electrodes 216 (or the fifth electrodes 218) and the first electrodes 224.

Due to electrodes of the first and second substrates 210 and 220 having different extension directions, the stereo display apparatus described in the present embodiment not only can have the adjustable viewing distance thereto but also can have the adjustable viewing direction. In addition, the stereo display apparatus described in the present embodiment has the effects and advantages similar to those of the stereo display apparatus 1000 described in the first embodiment, and thus no further descriptions are given hereinafter.

### Third Embodiment

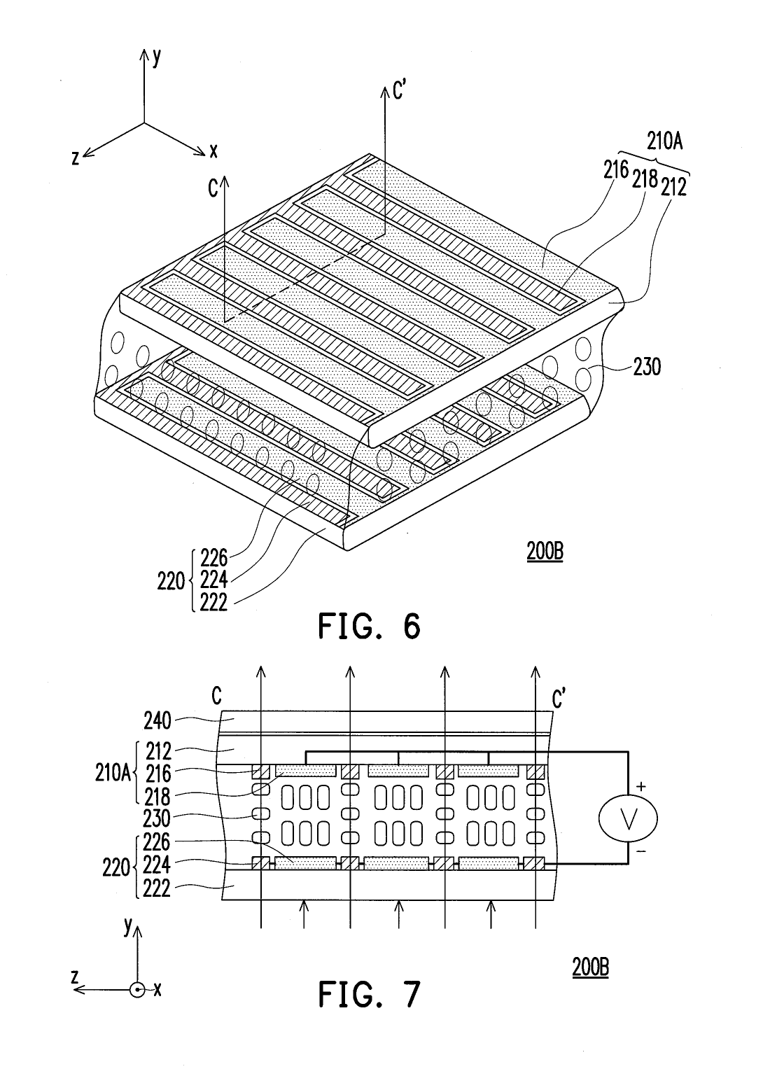

The stereo display apparatus described in the present embodiment is similar to the stereo display apparatus described in the second embodiment, and thus the same or similar reference numerals used in the present embodiment and in the first embodiment represent the same or similar elements. The main difference therebetween lies in the structure of the adjustable barrier. FIG. 6 is a schematic three-dimensional view illustrating an adjustable barrier according to a third embodiment of the invention. FIG. 7 is a schematic cross-sectional view illustrating the adjustable barrier taken along a line segment CC′ depicted in FIG. 6. With reference to FIG. 6 and FIG. 7, the adjustable barrier 200B described in the present embodiment is similar to the adjustable barrier 200A described in the second embodiment. The difference therebetween lies in that the relative position of the first and second substrates 210A and 220 described in the present embodiment is distinct from that described in the first embodiment. Said difference will be demonstrated below, while the similarity will not be further described.

In the present embodiment, an extension direction of the fourth electrodes 216 (or the fifth electrodes 218) of the first substrate 210A is substantially parallel to an extension direction of the first electrodes 224 and an extension direction of the second electrodes 226 of the second substrate 220. To be more specific, the fourth electrodes 216 may be aligned to the first electrodes 224, while the fifth electrodes 218 may be aligned to the second electrodes 226. However, the invention is not limited thereto. In other embodiments of the invention, the pitch between every two of the first electrodes 224, the pitch between every two of the second electrodes 226, the pitch between every two of the fourth electrodes 216, and the pitch between every two of the fifth electrodes 218 may be different from one another, such that the optimum viewing distance to the stereo display apparatus described in the present embodiment may be adjusted accurately. The way to adjust the optimum viewing distance is similar to that described above and is thus not reiterated hereinafter.

In addition, the stereo display apparatus described in the present embodiment has the effects and advantages similar to those of the stereo display apparatus described in the second embodiment, and therefore no further descriptions are given hereinafter.

To sum up, in the stereo display apparatus described in one embodiment of the invention, the electrodes that are not arranged equidistantly are configured on the adjustable barrier, such that the stereo display apparatus described in one embodiment of the invention may have the adjustable optimum viewing distance thereto.

Moreover, the stereo display apparatus described in another embodiment of the invention further includes a control unit. The control unit is likely to change the brightness of the image provided by the display panel according to the transmittance of the adjustable barrier, such that a user may sense the same image brightness even though the stereo display apparatus is switched to a different mode.

On the other hand, according to still another embodiment of the invention, the first substrate and the second substrate may respectively have the electrodes with different extension directions; thereby, the stereo display apparatus described in the present embodiment not only can have the adjustable viewing distance thereto but also can be characterized by the adjustable viewing direction.

What is claimed is:

1. A stereo display apparatus comprising:
a display panel providing an image;
an adjustable barrier located on a transmission path of the image, the adjustable barrier comprising:
a first substrate;
a second substrate disposed opposite to the first substrate, the second substrate comprising:
a second plate;
a plurality of first electrodes located on the second plate and between the second plate and the first substrate, wherein the first electrodes are arranged in a same space, and a first space is between any two adjacent first electrodes of the first electrodes; and
a plurality of second electrodes located on the second plate and between the second plate and the first substrate, wherein and the first electrodes are alternately arranged and the second electrodes are arranged in a same space, a second space is between any two adjacent second electrodes of the second electrodes, and the first space is greater than the second space; and
a display medium located between the first substrate and the second substrate.

2. The stereo display apparatus as recited in claim 1, wherein the first electrodes and the second electrodes are alternately arranged along a first direction, and a width of each of the first electrodes along the first direction is less than a width of each of the second electrodes along the first direction.

3. The stereo display apparatus as recited in claim 1, wherein a first pitch is between any two adjacent first electrodes of the first electrodes, a second pitch is between any two adjacent second electrodes of the second electrodes, and the first pitch is substantially equal to the second pitch.

4. The stereo display apparatus as recited in claim 1, wherein the first electrodes and the second electrodes are alternately arranged along a first direction, each of the first electrodes and each of the second electrodes are bar-shaped electrodes extending along a second direction, and the second direction and the first direction are staggered.

5. The stereo display apparatus as recited in claim 1, wherein the first electrodes and the second electrodes are coplanar.

6. The stereo display apparatus as recited in claim 1, wherein the first substrate comprises:
a first plate; and
a third electrode located on the first plate and between the first plate and the second plate, wherein the third electrode is a complete conductive pattern and entirely covers the first electrodes and the second electrodes.

7. The stereo display apparatus as recited in claim 1, wherein the first substrate comprises:
a first plate; and
a plurality of fourth electrodes located on the first plate and between the second plate and the first plate, wherein the fourth electrodes are equidistantly arranged, a fourth space is between any two adjacent fourth electrodes of the fourth electrodes, the first electrodes and the second electrodes are alternately arranged along a first direction, the fourth electrodes are arranged along a second direction, and the second direction and the first direction are staggered.

8. The stereo display apparatus as recited in claim 7, the first substrate further comprising a plurality of fifth electrodes located on the first plate and between the second plate and the first plate, wherein the fourth electrodes and the fifth electrodes are alternately arranged along the second direction, the fifth electrodes are equidistantly arranged, a fifth space is between any two adjacent fifth electrodes of the fifth electrodes, and the fourth space is greater than the fifth space.

9. The stereo display apparatus as recited in claim 8, wherein a width of each of the fourth electrodes along the second direction is less than a width of each of the fifth electrodes along the second direction.

10. The stereo display apparatus as recited in claim 8, wherein a third pitch is between any two adjacent fourth electrodes of the fourth electrodes, a fourth pitch is between any two adjacent fifth electrodes of the fifth electrodes, and the third pitch is substantially equal to the fourth pitch.

11. The stereo display apparatus as recited in claim 8, wherein each of the fourth electrodes and each of the fifth electrodes are bar-shaped electrodes extending along an third direction, and the second direction and the third direction are staggered.

12. The stereo display apparatus as recited in claim 8, wherein the fourth electrodes and the fifth electrodes are coplanar.

13. The stereo display apparatus as recited in claim 1, wherein the first substrate comprises:
a first plate; and
a plurality of fourth electrodes located on the first plate and between the second plate and the first plate, wherein the fourth electrodes are equidistantly arranged, a fourth space is between any two adjacent fourth electrodes of the fourth electrodes, the first electrodes and the second electrodes are alternately arranged along a first direction, the fourth electrodes are arranged along a second direction, and the second direction is substantially parallel to the first direction.

14. The stereo display apparatus as recited in claim 13, the first substrate further comprising a plurality of fifth electrodes located on the first plate and between the second plate and the first plate, wherein the fourth electrodes and the fifth electrodes are alternately arranged along the second direction, the fifth electrodes are equidistantly arranged, a fifth space is between any two adjacent fifth electrodes of the fifth electrodes, and the fourth space is greater than the fifth space.

15. The stereo display apparatus as recited in claim 14, wherein the first electrodes are substantially aligned to the fourth electrodes, and the second electrodes are substantially aligned to the fifth electrodes.

16. The stereo display apparatus as recited in claim 14, wherein the first space, the second space, the fourth space, and the fifth space are different from one another.

17. The stereo display apparatus as recited in claim 14, wherein each of the fourth electrodes and each of the fifth electrodes are bar-shaped electrodes extending along a third direction, and the second direction and the third direction are staggered.

18. The stereo display apparatus as recited in claim 14, wherein the fourth electrodes and the fifth electrodes are coplanar.

19. The stereo display apparatus as recited in claim 1, wherein the adjustable barrier further comprises a polarizer connected to the first substrate.

20. The stereo display apparatus as recited in claim 1, further comprising a control unit suitable for adjusting brightness of the image according to transmittance of the adjustable barrier.
